(19) United States
(12) Patent Application Publication
(10) Pub. No.: US 2006/0143928 A1
(43) Pub. Date: Jul. 6, 2006

(54) Power tool with a tool storage

(76) Inventor: Shuming Wu, Nanjing City (CN)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/318,661

(22) Filed: Dec. 27, 2005

(30) Foreign Application Priority Data
Jan. 4, 2005 (CN) 200520069605.2

(51) Int. Cl. B26B 11/00

(52) U.S. Cl. 30/124; 30/392

(57) ABSTRACT

The present invention discloses a power tool with a tool storage compartment. The power tool includes a housing and a tool storage compartment detachably mounted onto the outside of the housing for storing spare tools and power tool accessories. The power tool housing contains at least one guide bar and a sliding slot is disposed on a surface of the tool storage compartment acting with the housing. The guide bar and the sliding slot are engageable with each other, such that the tool storage compartment is slidable relative to the housing. The tool storage compartment and the housing respectively comprise fixing means for engaging with each other. The tool storage compartment can be automatically locked when it slides along the guide bar and reaches a predetermined position. Additionally, the tool storage compartment further includes a mechanism for fastening the tools and a device for conveniently accessing the tools. Provided with such mechanisms, the power tool is equipped with a detachable tool storage compartment that allows the user to conveniently access the tools or tool accessories at any moment.

### CROSS-REFERENCE TO RELATED APPLICATIONS

This application claims priority under 35 U.S.C. § 119 to Chinese Application No. 200520069605.2, filed on Jan. 4, 2005.

### FEDERALLY SPONSORED RESEARCH OR DEVELOPMENT

None.

### TECHNICAL FIELD

The invention relates to a power tool, and more particularly to a cutting tool with a tool storage, for storing types of tools and tool accessories which might be needed by the user during the use and operation of the power tool.

### BACKGROUND OF THE INVENTION

Power tools, especially portable cutting tools, such as jig saws, circular saws and electric drills, are widely used in different locations and for different applications because of their portability. During operation, power tool accessories (e.g., saw blades, drill bits, etc.) are needed to be replaced to accommodate workpieces that have different material or shapes. In addition, tools and tool accessories might need to be replaced when a saw blade or drill bit becomes too dull. If a separate tool storage case is provided for storing tools, the tool storage case must be carried with the power tool at every working opportunity. This is extremely inconvenient. Accordingly, it is desirable to provide a chamber in the power tool housing or attach a tool storage compartment to the housing for receiving and storing additional tools and/or power tool accessories.

U.S. Pat. No. 3,353,573 discloses a jig saw with a chamber applied in a housing for storing saw blades. U.S. Pat. No. 6,189,217 discloses a saber saw with spare saw blades detachably stored in the housing. U.S. Pat. No. 6,334,743 discloses an electric drill that comprises accommodation spaces in the handle and the rear side of the housing for receiving spare drill bits therein. For receiving those tools, a relatively large space must be provided in the housing of the power tool, and the space capability is relatively limited.

Meanwhile, during operation of the power tool, tools and tool accessories are subjected to high levels of vibrations, which make securing the tools and/or accessories difficult. Furthermore, the tools are inconvenient in accessing because the tool storage has a relative small volume.

The terms tool and tool accessory shall mean any power tool component which operates directly on a workpiece, such as a saw blade, a drill bit and so on. The terms shall also include a tool or other apparatus having no direct relationship to the power tool (e.g., a laser level, a tape measure, fasteners, sand paper, etc.).

The present invention is provided to solve the problems discussed above and other problems, and to provide advantages and aspects not provided by prior tools of this type. A full discussion of the features and advantages of the present invention is deferred to the following detailed description, which proceeds with reference to the accompanying drawings.

### SUMMARY OF THE INVENTION

An object of the present invention is to provide a power tool with a tool and/or tool accessory storage compartment that is detachably mounted on the tool housing.

To achieve the above-mentioned object, a power tool of the present invention comprises a tool accessory storage compartment, which includes a fixing device, and two sliding slots that are positioned on a bottom surface which is to be joined to a housing of the power tool. A locking device is contained on the housing to be engageable with the fixing device of the tool storage. At least one pair of guide bars project outwardly and are engageable with the sliding slots. An action surface is formed between each pair of sliding slot and guide bar.

Another object of the present invention is to provide a power tool with a tool storage compartment. The tool storage compartment contains a fastening means for fixing the tools within the compartment, and consequently to prevent the tools from being vibrated when the power tool is being operated. A still further object of the present invention is to conveniently allow access to the tools from the tool storage compartment.

Provided with such mechanisms, the power tool is equipped with a detachable tool storage compartment, which facilitates the user to replace the tools at any moment. Moreover, it is very convenient to access the tools and assemble or disassemble the tool storage compartment from the tool housing. Furthermore, because the tool storage compartment is equipped with means for securing it to the housing, it is less likely that vibrations caused during use of the power tool will move the tool storage compartment around or even slide out of the engagement with the housing.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

The accompanying drawings illustrate a preferred embodiment of the invention, which will be described in great detail hereinafter and take the jig saw as an example.

FIG. 1 is a diagrammatic drawing of a jig saw with a blade storage being partially assembled to the housing;

FIG. 2 is a diagrammatic drawing showing a part of the housing that is used for fitting with the blade storage;

FIG. 3 is a perspective view of the back side of the blade storage, which surface is to be engaged with the housing; and

FIG. 4 is perspective view of the front side of the blade storage, clearly showing an end portion of blade chamber members.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

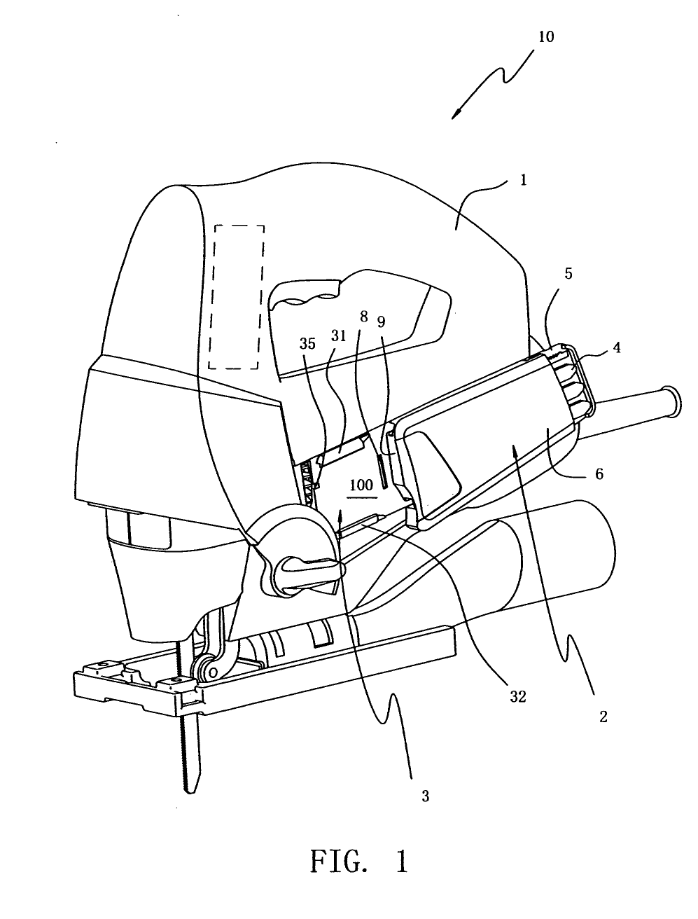

Referring to FIG. 1, a jig saw 10 includes a housing 1, a locking device 3 on the outer surface of the housing 1 for detachably connecting a blade storage compartment 2. The locking device 3 is not limited to the position shown in the drawings, other proper positions on the housing, such as the position shown in dashed lines of FIG. 1 are also contemplated by the present invention.

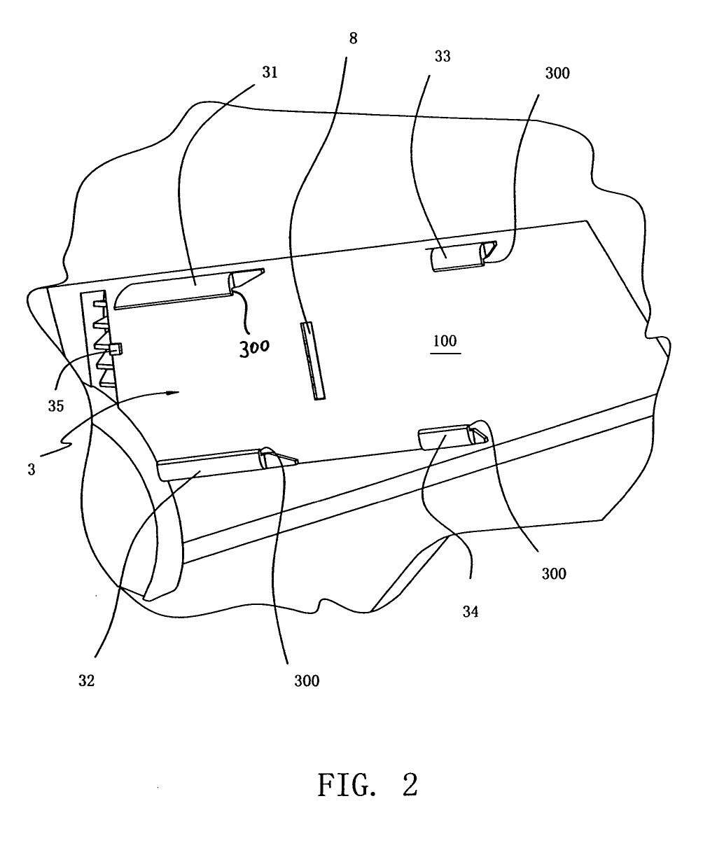

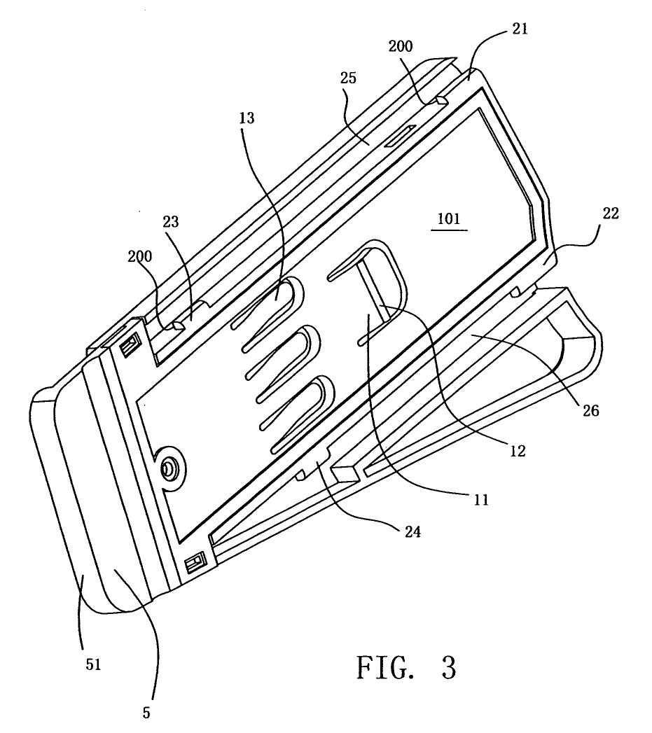

Further referring to FIGS. 2 and 3, the locking device 3 includes guide bars 31, 32, 33, and 34, which are arranged to be engagable with sliding slots 25, 26 of the tool storage compartment 2. As shown specifically in FIG. 2, each guide bar further includes a first action surface 300. The sliding slots 25, 26 comprise four tongues 21, 22, 23 and 24 therein, and each of which contains a second action surface 200 (as shown in FIG. 3). The sliding slots 25,26 and the guide bars 31-34 are positioned and shaped so that engagement between the slots and guide bars can be easily achieved. The guide bars may slide in corresponding sliding slots, and the first action surface 300 contacts with the second action surface 200. Thus, the blade storage compartment 2 may slide along the guide bars 31-34, and is held from falling down from a engagement surface 100 of the housing 1 because of the engagement between the first action surface 300 and the second action surface 200. While the preferred embodiment shown in FIGS. 1-4 show the guide bars 31-34 formed on the engagement surface 100 of the housing 1 and sliding slots 25, 26 are formed on the tool storage compartment 2, it should be understood by those having skill in the art that the guide bars 31-34 could be formed on the tool storage compartment 2 while the sliding slots 25, 26 are formed in the housing 1.

It is also desireable to have a fixing means to ensure steady connection between the blade storage compartment 2 and the housing 1. Referring to FIGS. 1 and 2, the housing engagement surface 100 contains a slot 8 having a protrusion 35 formed on one end portion thereof. An elastic member 11 is formed on a bottom surface 101 of the blade storage compartment 2 as shown in FIG. 3. The elastic member 11 further includes a projected ridge 12 to be properly engaged with the slot 8. It is configured so that the blade storage compartment 2 slides along the guide bars 31-34 until a front end 9 of the blade storage compartment 2 is stopped by the protrusion 35. At this point, the projected ridge 12 drops into the slot 8 by the urging of the elastic piece 11, fixing the blade storage compartment 2 to the housing 1 of the jig saw 10, and ensures a secure connection even during operation of the saw 10.

The fixing means as mentioned above may be accomplished in other ways. For example, magnets may be disposed in the housing 1 and/or the blade storage compartment 2, so that they cooperate with each other to detachably secure the blade storage compartment 2 to the housing 1. In another embodiment, latches may be respectively mounted to the front end 9 of the blade storage compartment 2 and the housing 1 to secure the two to one another. The latches may be any types as that have been widely used for detachably connecting two components, and which is commonly known by those skilled in the mechanical field.

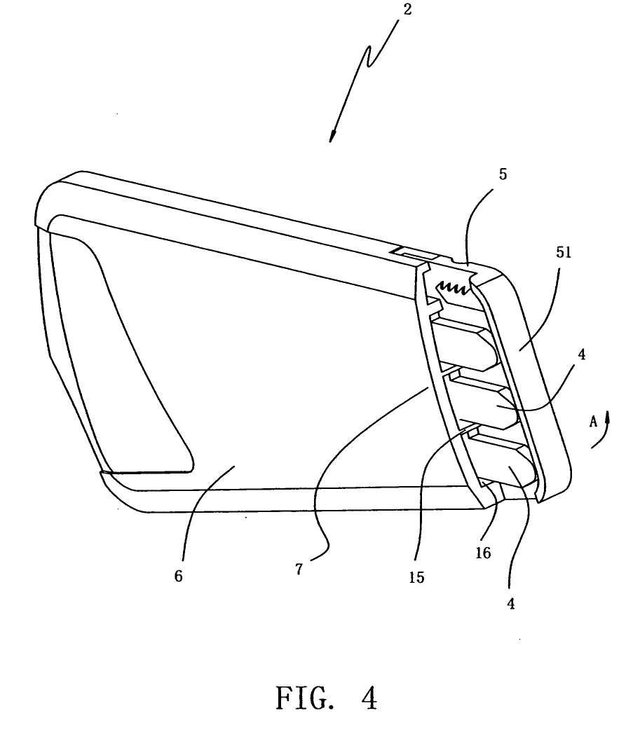

Referring to FIG. 4, chamber members or elongated compartments 16 are formed by a plurality of clapboards 15 in the tool storage compartment 2 for storing tools (e.g., saw blades 4). Walls of each chamber member 16 preferably comprise a device for fixing the saw blade 4. In the present embodiment, walls of each chamber member 16 are formed by the cover 6 and the bottom surface 101 of the blade storage compartment 2, as shown in FIG. 3, the bottom surface 101 of the blade storage 2 comprises three pieces of press pieces 13, which respectively extend toward the insides of the three chamber members 16 and press against the saw blades 4. The press pieces 13 are somewhat resilient. Thus, even during the cutting of the jig saw 10, the saw blades 4 that are saved in the blade storage compartment 2 will not vibrate and move around inside the storage compartment 2. The chamber members 16 may also be in the form of slots or grooves formed in the storage compartment 2 that correspond to the size and shape of the tools to be stored in the storage compartment 2.

Another embodiment of the device for fixing the saw blades 4 is that, magnets are arranged in or about the chamber members 16, and the saw blades 4 are accordingly fixed in the chamber members 16 by magnetic force.

In a preferred embodiment, the chamber members 16 of the blade storage 2 has an open end 7, which comprises a resilient pad 5 at a position near the bottom surface 101. The resilient pad 5 extends beyond the open end 7 and has a folded stopping flange 51. Accordingly, the saw blade 4 can be conveniently accessed when pushing the resilient pad 5 in a direction as shown by arrow A in FIG. 4. When the resilient pad 5 rebounds to a normal position as shown in FIGS. 1, 3 and 4, the stopping flange 51 of which keeps the saw blades 4 from sliding down from the blade storage 2. The resilient pad 5 is preferably made up of soft elastic material with a relative high friction factor, such as rubber etc. thus, friction force produced between the saw blades and the resilient pad 5 further increases the stabilization of the saw blade 4 in the blade storage 2.

While the invention has been described in the specification and illustrated in the drawings with reference to a jig saw and saw blades as preferred embodiments, it will be understood by those skilled in the art that such tool storage may also be applied to other power tools, especially handheld cutting tools such as saber saw, drill, hammer and so on, and other tools or tool accessories. Based on understanding from the specification described above and the accompanying drawings, the tool storage may be applied to other power tools by those skilled in the art through the same way or by taking an equivalent change. That is, the constitution of the above-mentioned blade storage and the connection between the blade storage and the jig saw may be also applied to other power tools.

While the specific embodiments have been illustrated and described, numerous modifications come to mind without significantly departing from the spirit of the invention, and the scope of protection is only limited by the scope of the accompanying Claims.

What is claimed is:

1. A power tool with a tool storage compartment, the power tool comprising:
a housing having an outer surface; and
a tool storage compartment detachably mounted on the outer surface of the housing, the tool storage compartment having a chamber member therein for storing tools.

2. The power tool of claim 1 further comprising:
a recess in the housing exposing an engagement surface;
a locking device formed on the engagement surface;
a slot formed in the tool storage compartment configured to receive the locking device on the engagement surface; and
means for fixing the tool storage compartment in the recess formed in the housing.

3. The power tool of claim 1, wherein the tool storage compartment includes a chamber member for storing the tools and means for fastening the tools within the chamber member.

4. The power tool of claim 3, wherein the means for fastening comprises at least one resilient press pieces extending inside of the chamber member.

5. The power tool of claim 3, wherein the means for fastening comprises a magnet.

6. The power tool of claim 1, wherein the tool storage compartment comprises an open end and a resilient member disposed near the open end for keeping the tools from falling out of the storage compartment.

7. The power tool of claim 6, wherein the resilient member has a first end attached to the tool storage compartment and a second end that extends around the open end of the storage compartment to form a stopping flange.

8. The power tool of claim 1 further comprising:
at least one guide bar extending outwardly from the housing;
at least one slot formed in the tool storage compartment for engaging the at least one guide bar extending outwardly from the housing;
a recess formed in the housing; and
a protrusion extending from the tool storage compartment such that the tool storage compartment may be slid along the at least one guide bar until the protrusion mates with the recess to connect the tool storage compartment to the housing of the power tool.

9. A power tool comprising:
a housing;
a tool storage compartment;
means for detachably connecting the tool storage compartment to the housing; and
means for fixing tools within the tool storage compartment.

10. The power tool of claim 9, wherein the means for detachably connecting the tool storage to the housing comprises first and second guide bars formed on one of either the housing or the tool storage compartment and first and second sliding slots formed on the other of the housing or the tool storage compartment.

11. The power tool of claim 10, wherein the housing has an engagement surface and the tool storage compartment has a bottom surface that engages the engagement surface of the housing and the means for detachably connecting the storage compartment to the housing further comprises a recess formed in the engagement surface of the housing and a projection member extending from the bottom surface of the tool storage compartment.

12. The power tool of claim 11, wherein when the bottom surface of the tool storage compartment is slid into contact with the engagement surface of the housing and the projection member is aligned with the recess formed in the engagement surface the tool storage compartment is connected to the housing.

13. A power tool comprising:
a housing having a recess formed therein, the recess having an engagement surface with at least two opposing guide bars extending therefrom;
a tool storage compartment having a first and second sliding slot for receiving the opposing guide bars;
means for securing tools within the tool storage compartment;
wherein the tool storage compartment is removably connected to the housing by aligning the guide bars within the sliding slots and sliding the tool storage compartment into the recess formed in the housing.

14. The power tool of claim 13, wherein the means for securing tools within the tool storage compartment comprises at least one elastic press piece which applies a force against the tools in the tool storage compartment when the tool storage compartment is connected to the housing.

15. The power tool of claim 13, wherein the means for securing the tools within the tool storage compartment comprises a magnet.

16. The power tool of claim 13, wherein the power tool further comprises means for fixing the tool storage compartment to the housing.

17. The power tool of claim 16, wherein the means for fixing the tool storage compartment to the housing comprises a magnet.

18. The power tool of claim 16, wherein the means for fixing the tool storage compartment to the housing comprises a recess formed in the engagement surface of the housing and a projection member extending from a bottom surface of the tool storage compartment which engages the recess when the slots of the tool storage compartment are engaged by the guide bars of the housing.
